(19) United States
(12) Patent Application Publication
(10) Pub. No.: US 2004/0265611 A1
(43) Pub. Date: Dec. 30, 2004

(54) Method for producing oriented acrylate hotmelts

(76) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/496,150

(22) PCT Filed: Nov. 21, 2002
(86) PCT No.: PCT/EP02/13070

(30) Foreign Application Priority Data
Nov. 22, 2001 (DE) 101 57 154.2

(51) Int. Cl. B32B 27/30

(52) U.S. Cl. 428/522

(57) ABSTRACT

A process for preparing an anisotropic pressure sensitive adhesive, characterized in that it comprises crosslinking an already pre-oriented polymer based on acrylate and/or methacrylate by irradiation with UV light.

The invention relates to a process for the preparation of anisotropic polyacrylate pressure sensitive adhesives (PSAs) to pressure sensitive adhesives prepared according to this process, and to the use thereof.

As a result of ever-increasing environmental obligations and cost pressure, there is at present a trend toward preparing PSAs with little if any solvent. This objective can most easily be realized by means of the hotmelt technology. A further advantage is the reduction in production time. Hotmelt lines can laminate adhesives much more quickly to carriers or release paper, and so can save time and money.

However, the hotmelt technology always imposes stringent requirements on the adhesives. For high-grade industrial applications, particular preference is given to polyacrylates, on account of their transparency and stability to weathering.

In order to prepare acrylic hotmelts, conventionally, acrylic monomers are polymerized in solution and the solvent is then removed in the extruder in a concentrating process.

Besides the advantages in transparency and weathering stability, however, acrylate PSAs are also required to meet exacting requirements in the shear strength field. This is achieved by means of polyacrylates of high molecular weight and high polarity with subsequent efficient crosslinking.

For the properties of PSAs, the orientation of the macromolecules also plays an important part. During the preparation, further processing, or subsequent (mechanical) stressing of polymers or polymer compositions, there may be high degrees of orientation of the macromolecules in preferential directions within the polymer assembly as a whole; these orientations may lead to special properties in the corresponding polymers. Some examples of properties which can be influenced by the degree of orientation include the strength and stiffness of the polymers and of the plastics produced from them, thermal conductivity, thermal stability, and anisotropy in respect of permeability to gases and liquids. In addition, however, oriented polymers may also exhibit anisotropic stress/strain characteristics.

One important property dependent on the orientation of the monomer units is the refraction of light (expressed by the corresponding refractive index, n) and the retardation δ and also the shrink behavior of free films of the corresponding oriented PSAs (“shrinkback”).

From the standpoint of process engineering, advantages are afforded by electron beam crosslinking. For example, it is possible to “freeze in” certain states by the crosslinking process.

The retention of the partial orientation in partially crystalline rubber adhesives is described in U.S. Pat. No. 5,866,249. As a result of the anisotropic adhesive properties, innovative PSA applications were defined. However, the cited text describes only natural-rubber PSAs, which possess a range of disadvantages as compared with conventional acrylic PSAs for certain fields of use; this text cannot therefore be transferred to acrylic PSAs.

In DE 100 34 069.5, a process is described for preparing oriented acrylic PSAs by means of electron irradiation. For implementation from the process engineering standpoint, electron irradiation also has its disadvantages. For instance, the electron beams penetrate not only the acrylic PSA but also the carrier material. Electron irradiation therefore causes damage to the PSA tape. In general, the quality of crosslinking is likewise limited as compared with other crosslinking mechanisms, since as a result of the high energy some decomposition of the polymer is observed. Moreover, the expense of electron irradiation apparatus is very high.

DE 100 52 955.0 shows the use of oriented acrylic PSAs of this kind, again prepared by the process described in DE 100 34 069.5.

There is a need for a process for preparing oriented PSAs by a crosslinking mechanism, which is accessible without great expenditure on apparatus and which prevents polymer degradation.

It is therefore an object of the invention to provide a process for preparing oriented polyacrylate compositions which does not have the abovementioned disadvantages of the prior art.

Surprisingly and in a manner unforeseeable for the skilled worker, this object is achieved by a process for preparing oriented PSAs as described in the main claim.

The invention accordingly provides a process for preparing anisotropic pressure sensitive adhesives for which a preoriented polymer based on acrylate and/or methacrylate is crosslinked by irradiation with UV light.

An especially preferred procedure adopted in this case is that the irradiation with UV light is carried out with the preoriented polymer present as a layer.

In one advantageous onward development of the process of the invention the polymer layer is produced from the melt, in particular by coating onto a permanent or temporary substrate through a melt die, through an extrusion die or by means of a roller coating method.

Likewise claimed in accordance with the invention is a process for preparing anisotropic pressure sensitive adhesives for which a monomer mixture consisting of at least 50% by weight of acrylic monomers from the group of the compounds of the following general formula G1

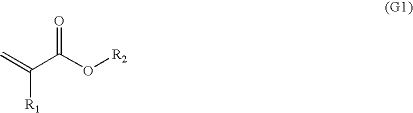

with R¹ independently at each occurrence chosen from H and/or CH₃ and R² independently at each occurrence chosen from the group of the branched or unbranched, saturated, substituted or unsubstituted hydrocarbon chains having 2 to 30 carbon atoms is polymerized to form a polymer, from which a polymer layer is produced, the polymer being oriented during layer production, and the oriented polymer is crosslinked by irradiation with UV light.

It is advantageous if the average molecular weight M_{w} of the polymer is at least 200 000 g/mol.

The polymers of the processes of the invention are very advantageously prepared as follows:

The monomers are chosen such that the resulting polymers can be used as pressure sensitive adhesives at room temperature or higher temperatures, particularly such that the resulting polymers possess pressure sensitive adhesive properties in accordance with the “Handbook of Pressure Sensitive Adhesive Technology” by Donatas Satas (van Nostrand, N.Y., 1989).

In order to obtain a preferred polymer glass transition temperature T_{G}≦10° C., in accordance with the above remarks, the monomers are very preferably selected in such a way, and the quantitative composition of the monomer mixture advantageously chosen in such a way, that the polymer is obtained with the desired T_{G} in accordance with the Fox equation (G2) (cf. T. G. Fox, Bull. Am. Phys. Soc. 1 (1956) 123).

$$\frac{1}{{T}_{G}} = {\sum }_{n}^{} \frac{{w}_{n}}{{T}_{G , n}} \qquad ( G2 )$$

In this equation, n represents the serial number of the monomers used, wₙ denotes the mass fraction of the respective monomer n (in % by weight) and T_{G,n} denotes the respective glass transition temperature of the homopolymer of the respective monomer n, in K.

In one very preferred procedure, use is made of acrylic or methacrylic monomers, very preferably according to the above formula G1. Acrylates and methacrylates having hydrocarbon radicals R² composed of 2 to 30 carbon atoms, preferably 4 to 14 carbon atoms, very preferably 4 to 9 carbon atoms, are advantageous. Specific examples, without wishing to be restricted by this listing unnecessarily, include methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further advantageous classes of compounds for the monomers include monofunctional acrylates and methacrylates of bridged cycloalkyl alcohols, composed of at least 6 carbon atoms. The cycloalkyl alcohols may also be substituted, by C₁₋₆ alkyl groups, halogens or cyano groups, for example. Specific examples include cyclohexyl methacrylates, isobornyl acrylate, isobornyl methacrylate, and 3,5-dimethyladamantyl acrylate.

In a further favorable procedure, monomers are used which carry polar groups such as carboxyl, sulfonic and phosphonic acid, hydroxyl, lactam and lactone, N-substituted amide, N-substituted amine, carbamate, epoxy, thiol, ether, alkoxy, and cyano or the like.

Examples of moderate basic monomers are N,N-dialkyl-substituted amides, such as N,N-dimethylacrylamide, N,N-dimethylmethacrylamide, N-tert-butylacrylamide, N-vinyl-pyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this list not being conclusive.

Further preferred examples for monomers which can be used according to the invention are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this list not being conclusive.

In another very preferred procedure, monomers used include vinyl esters, vinyl ethers, vinyl halides, vinylidene halides, and vinyl compounds with aromatic cycles and heterocycles in the α position. Here again, mention may be made nonexclusively of some examples: vinyl acetate, vinylformamide, vinylpyridine, ethyl vinyl ether, vinyl chloride, vinylidene chloride, and acrylonitrile.

Advantageously, monomers which possess a high static glass transition temperature can be added to the comonomers described. Suitable monomers of this kind include aromatic vinyl compounds, such as styrene, in which case the aromatic nuclei are preferably composed of C₄ to C₁₈ units and may also contain heteroatoms. Particularly favorable examples to be chosen include 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenyl acrylate and methacrylate, 2-naphthyl acrylate and methacrylate, and mixtures of the above monomers, this list not being conclusive.

In another very preferred version, moreover, photoinitiators containing a copolymerizable double bond are used. Suitable photoinitiators include Norrish I and Norrish II photoinitiators. Examples are benzoin acrylate and an acrylated benzophenone from UCB (Ebecryl P 36®). In principle it is possible to copolymerize any photoinitiator which is known to the skilled worker and which is able to crosslink the polymer by a free-radical mechanism under UV irradiation. An overview of possible photoinitiators which can be used and which can be functionalized with a double bond is given in Fouassier: “Photoinitiation, Photopolymerization and Photocuring: Fundamentals and Applications”, Hanser-Verlag, Munich 1995. For further details, recourse may be made to Carroy et al. in “Chemistry and Technology of UV and EB Formulation for Coatings, Inks and Paints”, Oldring (Ed.), 1994, SITA, London.

In order to prepare the poly(meth)acrylate PSAs it is advantageous to carry out conventional radical polymerizations. For the polymerizations proceeding by a radical mechanism it is preferred to use initiator systems which additionally comprise further radical initiators for the polymerization, especially thermally decomposing, radical-forming azo or peroxo initiators. In principle, however, any customary initiators that are familiar to the skilled worker for acrylates are suitable. The production of C-centered radicals is described in Houben Weyl, Methoden der Organischen Chemie, Vol. E 19a, pp. 60-147. These methods are employed preferentially in analogy.

Examples of radical sources are peroxides, hydroperoxides, and azo compounds; some nonexclusive examples of typical radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version, 1,1′-azobis(cyclohexanecarbonitrile) (Vazo 88™ from DuPont) or azodiisobutyronitrile (AIBN) is used as radical initiator.

The free-radical addition polymerization is preferably carried out such that the average molecular weights M_{w} of the polymers formed therein are at least 200 000 g/mol, advantageously in a range from 200 000 to 4 000 000 g/mol; in particular such that the polymers can be employed as pressure sensitive adhesives. Specifically for further use as hotmelt pressure sensitive adhesives, PSAs having average molecular weights M_{w} of from 600 000 to 800 000 g/mol are prepared. The average molecular weight is determined by size exclusion chromatography (GPC) or matrix-assisted laser desorption/ionization mass spectrometry (MALDI-MS).

The polymerization may be carried out in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that in the course of monomer conversion the reaction mixture is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones, and the like, and also derivatives and mixtures thereof.

The polymerization time is between 4 and 72 hours, depending on conversion and temperature. The higher the reaction temperature can be chosen, i.e., the higher the thermal stability of the reaction mixture, the lower the reaction time that can be chosen.

For the initiators which undergo thermal decomposition, the introduction of heat is essential to initiate the polymerization. For the thermally decomposing initiators the polymerization can be initiated by heating at from 50 to 160° C., depending on initiator type.

Another advantageous preparation process for the polyacrylate PSAs is anionic polymerization. In this case it is preferred to use inert solvents as the reaction medium, such as aliphatic and cycloaliphatic hydrocarbons, for example, or else aromatic hydrocarbons.

In this case the living polymer is generally represented by the structure P_{L}(A)-Me, in which Me is a metal from group I, such as lithium, sodium or potassium, and P_{L}(A) is a growing polymer block of the monomers A. The molar mass of the polymer to be prepared is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, with this list making no claim to completeness. Furthermore, initiators based on samarium complexes are known for the polymerization of acrylates (Macromolecules, 1995, 28, 7886) and can be used here.

Moreover, it is also possible to use difunctional initiators, such as 1,1,4,4-tetraphenyl-1,4-dilithiobutane or 1,1,4,4-tetraphenyl-1,4-dilithioisobutane. Coinitiators may likewise be used. Suitable coinitiators include lithium halides, alkali metal alkoxides or alkylaluminum compounds. In one very preferred version the ligands and coinitiators are chosen such that acrylic monomers, such as n-butyl acrylate and 2-ethylhexyl acrylate, for example, can be polymerized directly and need not be generated in the polymer by a transesterification with the corresponding alcohol.

In order to prepare polyacrylate PSAs having a narrow molecular weight distribution, controlled radical polymerization methods are also advantageously suitable. For the polymerization it is then preferred to use a control reagent of the general formula:

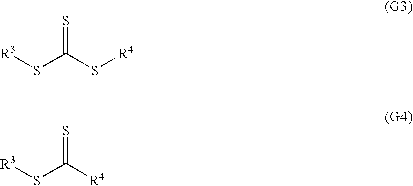

in which R³ and R⁴, chosen independently of one another or identical, are

branched and unbranched C₁ to C₁₈ alkyl radicals; C₃ to C₁₈ alkenyl radicals; C₃ to C₁₈ alkynyl radicals;

C₁ to C₁₈ alkoxy radicals;

C₃ to C₁₈ alkynyl radicals; C₃ to C₁₈ alkenyl radicals; C₁ to C₁₈ alkyl radicals substituted by at least one OH group or a halogen atom or a silyl ether;

C₂ to C₁₈ heteroalkyl radicals having at least one oxygen atom and/or one NR* group in the carbon chain, R* representing any (especially organic) radical;

C₃ to C₁₈ alkynyl radicals, C₃ to C₁₈ alkenyl radicals, C₁ to C₁₈ alkyl radicals substituted by at, least one ester group, amine group, carbonate group, cyano group, isocyanato group and/or epoxide group and/or by sulfur;

C₃ to C₁₂ cycloalkyl radicals;

C₆ to C₁₈ aryl or benzyl radicals;

hydrogen.

Control reagents of type (G3) are composed preferably of further-restricted compounds, as follows:

Halogen atoms therein are preferably F, Cl, Br or I, more preferably Cl and Br. As alkyl, alkenyl, and alkynyl radicals in the various substituents, both linear and branched chains are outstandingly suitable.

Examples of alkyl radicals containing from 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having from 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having from 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

A suitable C₂-C₁₈ heteroalkyl radical having at least one oxygen atom in the carbon chain is, for example, —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl or further substituted phenyl, such as ethylbenzene, toluene, xylene, mesitylene, isopropylbenzene, dichlorobenzene or bromotoluene.

The above listings serve only as examples of the respective groups of compounds, and make no claim to completeness.

Moreover, compounds of the following types may also be used as control reagents

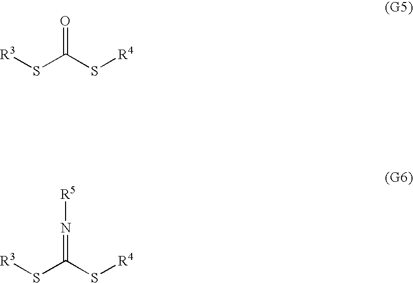

where R³ and R⁴ are chosen as above and likewise R⁵ may be chosen independently of R³ and R⁴ from the above-recited group for these radicals.

In the case of the conventional “RAFT” process, polymerization is normally carried out only to low conversions (WO 98/01478 A1) in order to obtain very narrow molecular weight distributions. As a result of the low conversions, however, these polymers cannot be used as PSAs and in particular not as hotmelt PSAs, since the high fraction of residual monomers adversely affects the technical adhesive properties; the residual monomers would contaminate the solvent recyclate in the concentration process and the corresponding self-adhesive tapes would exhibit very high outgassing behavior. In order to circumvent this drawback of low conversions, in one particularly preferred procedure the polymerization is initiated a number of times.

As a further controlled radical polymerization method it is possible to carry out nitroxide-controlled polymerizations. In an advantageous procedure, radical stabilization is effected using nitroxides of type (G7) or (G8):

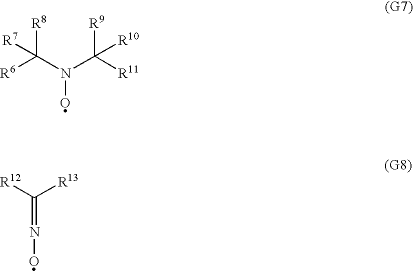

wobei R⁶, R⁷, R⁸, R⁹, R¹⁰, R¹¹, R¹², and R¹³ independently of one another denote the following compounds or atoms:

i) halides, such as chlorine, bromine or iodine,

ii) linear, branched, cyclic, and heterocyclic hydrocarbons having from 1 to 20 carbon atoms, which may be saturated, unsaturated or aromatic,

iii) esters —COOR¹⁴, alkoxides —OR¹⁵ and/or phosphonates —PO(OR¹⁶)₂, where R¹⁴, R¹⁵, and R¹⁶ stand for radicals from group ii).

Compounds of structures (G7) or (G8) may also be attached to polymer chains of any kind (primarily in the sense that at least one of the abovementioned radicals constitutes a polymer chain of this kind).

With more preference, controlled regulators are used for the polymerization of compounds of the following type:

2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL

2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl

N-tert-butyl 1-phenyl-2-methylpropyl nitroxide

N-tert-butyl 1-(2-naphthyl)-2-methylpropyl nitroxide

N-tert-butyl 1-diethylphosphono-2,2-dimethylpropyl nitroxide

N-tert-butyl 1-dibenzylphosphono-2,2-dimethylpropyl nitroxide

N-(1-phenyl-2-methylpropyl) 1-diethylphosphono-1-methylethyl nitroxide

di-t-butyl nitroxide

diphenyl nitroxide

t-butyl t-amyl nitroxide.

U.S. Pat. No. 4,581,429 A discloses a controlled-growth radical polymerization process which uses as its initiator a compound of the formula R′R″N—O—Y, in which Y denotes a free radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific radical compounds, such as phosphorus-containing nitroxides based on imidazolidine, are used. WO 98/44008 A1 discloses specific nitroxyls based on morpholines, piperazinones and piperazinediones. DE 199 49 352 A1 describes heterocyclic alkoxyamines as regulators in controlled-growth radical polymerizations. Corresponding further developments of the alkoxyamines or of the corresponding free nitroxides improve the efficiency for the preparation of polyacrylates (Hawker, contribution to the National Meeting of The American Chemical Society, Spring 1997; Husemann, contribution to the IUPAC World Polymer Meeting 1998, Gold Coast).

As a further controlled polymerization method, atom transfer radical polymerization (ATRP) can be used advantageously to synthesize the polyacrylate PSAs, in which case use is made preferably, as initiator, of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in U.S. Pat. No. 5,945,491 A, U.S. Pat. No. 5,854,364 A, and U.S. Pat. No. 5,789,487 A.

For further development, resins may be admixed to the polyacrylate PSAs. As tackifying resins for addition it is possible without exception to use any tackifier resins which are known and are described in the literature. As representatives, mention may be made of pinene resins, indene resins, and rosins, their disproportionated, hydrogenated, polymerized, esterified derivatives and salts, the aliphatic and aromatic hydrocarbon resins, terpene resins and terpene-phenolic resins, and also C5, C9, and other hydrocarbon resins. Any desired combinations of these and other resins may be used in order to adjust the properties of the resulting adhesive in accordance with what is desired. In general it is possible to use any resin which is compatible (soluble) with the corresponding polyacrylate; in particular, reference may be made to all aliphatic, aromatic, and alkylaromatic hydrocarbon resins, hydrocarbon resins based on pure monomers, hydrogenated hydrocarbon resins, functional hydrocarbon resins, and natural resins. Express reference is made to the depiction of the state of the art in the “Handbook of Pressure Sensitive Adhesive Technology” by Donatas Satas (van Nostrand, 1989).

Furthermore, it is also possible optionally to add plasticizers, fillers (e.g., fibers, carbon black, zinc oxide, titanium dioxide, chalk, solid or hollow glass beads, microbeads made of other materials, silica, silicates), nucleators, blowing agents, compounding agents and/or aging inhibitors, in the form for example of primary and secondary antioxidants or in the form of light stabilizers.

Additionally, crosslinkers and promoters for crosslinking may be admixed. Examples of suitable crosslinkers for UV crosslinking include difunctional or polyfunctional acrylates, difunctional or polyfunctional methacrylates, difunctional or polyfunctional isocyanates and/or difunctional or polyfunctional epoxides.

For crosslinking with UV light, UV-absorbing photoinitiators may be added to the polyacrylate PSAs. Useful photoinitiators which are very good to use include benzoin ethers, such as benzoin methyl ether and benzoin isopropyl ether, for example, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, for example, aromatic sulfonyl chlorides, such as 2-naphthylsulfonyl chloride, for example, and photoactive oximes, such as 1-phenyl-1,2-propanedione 2-(o-ethoxycarbonyl)oxime, for example.

The abovementioned photoinitiators and others which can be used, including those of the Norrish I or Norrish II type, may contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholine ketone, aminoketone, azobenzoin, thioxanthone, hexaarylbisimidazole, triazine, or fluorenone, it being possible for each of these radicals additionally to be substituted by one or more halogen atoms and/or one or more alkyloxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details, it is possible to consult Carroy et al. in “Chemistry and Technology of UV and EB Formulation for Coatings, Inks and Paints”, Oldring (Ed.), 1994, SITA, London.

In order to produce oriented PSAs, the polymers described above are preferably coated as hotmelt systems. For the production process it may therefore be necessary to remove the solvent from the polymer. In principle it is possible here to use any of the techniques known to the skilled worker. One very preferred technique is that of concentration using a single-screw or twin-screw extruder. The twin-screw extruder may be operated corotatingly or counterrotatingly. The solvent or water is distilled off preferably by way of several vacuum stages. Moreover, counterheating is carried out depending on the distillation temperature of the solvent. The residual solvent fractions are preferably <1%, more preferably <0.5% and very preferably <0.2%. The hotmelt is processed further from the melt.

In accordance with the processes of the invention the polymers are oriented so that they exhibit an anisotropy. Within the polymer there is an orientation of the macromolecules in preferential directions. This orientation is very advantageously realized during the production of a layer of the polymer.

In one preferred procedure, orientation within the PSA is produced by the coating process. For coating as a hotmelt, and hence also for orientation, it is possible to employ a variety of coating techniques. In one embodiment the polyacrylate PSAs are coated by a roll coating process, and the orientation is produced by one or more drawing processes. Various roll coating techniques are described in the “Handbook of Pressure Sensitive Adhesive Technology” by Donatas Satas (van Nostrand, N.Y., 1989). In another version the orientation is achieved by coating through a melt die. A distinction can be made here between the contact process and the noncontact process. Orientation of the PSA here can be produced on the one hand within the coating die, by virtue of the die design, or else following emergence from the die, by a drawing process. The orientation is freely adjustable. The draw ratio can be controlled, for example, by the width of the die gap. Drawing occurs whenever the layer thickness of the PSA film on the backing material to be coated is less than the width of the die gap.

In another preferred process, the orientation is achieved by extrusion coating. Extrusion coating is preferably performed using an extrusion die. The extrusion dies used may originate from one of the following three categories: T-dies, fishtail dies, and coathanger dies. The individual types differ in the design of their flow channel. Through the form of the extrusion die it is likewise possible to produce an orientation within the hotmelt PSA. Additionally, here, in analogy to melt die coating, it is likewise possible to obtain an orientation following emergence from the die, by drawing the PSA tape film.

In order to produce oriented acrylic PSAs, it is particularly preferred to carry out coating onto a permanent or temporary substrate, especially onto a carrier, using a coathanger die, specifically in such a way that a polymer layer is formed on the substrate by means of a movement of die relative to substrate.

The time which elapses between coating and crosslinking is preferably short. In one preferred procedure, coating is carried out after less than 60 minutes, in another preferred procedure, after less than 3 minutes, and in a very preferred procedure, in an inline process, after less than 5 seconds.

In one preferred version, coating is carried out directly onto a carrier material. Suitable carrier materials include, in principle, all materials known to the skilled worker, such as, BOPP, PET, PVC or nonwoven, foam, or release papers (glassine, HDPE or LDPE).

The best orientation effects are obtained by deposition onto a cold surface. It is thus advantageous for the carrier material during coating to be cooled directly by means of a roller. The roller can be cooled by a liquid film/contact film from the outside and/or inside, and/or by a coolant gas. The coolant gas may likewise be used to cool the adhesive emerging from the coating die. In one preferred procedure the roller is wetted with a contact medium, which is then located between the roller and the carrier material. Preferred embodiments for the implementation of such a technique are described later on below.

For this process it is possible to use both a melt die and an extrusion die. In one very preferred procedure the roller is cooled to room temperature, in an extremely preferred procedure to temperatures below 10° C. Advantageously, the roller ought to rotate. In a further procedure as part of this preparation process, moreover, the roller is used for crosslinking of the oriented PSA.

In a further preferred preparation process, the oriented PSA is coated onto a roller provided with a contact medium. As a result of the contact medium it is possible in turn to carry out very rapid cooling of the PSA.

As the contact medium a material is advantageously used which has the capacity to bring about contact between the PSA and the surface of the roller, especially a material which fills the cavities between carrier material and roller surface (for example, unevennesses in the roller surface, bubbles). In order to implement this technology, a rotating cooling roller is coated with a contact medium. In one preferred procedure the contact medium chosen is a liquid, such as water, for example.

Examples of appropriate additives to water as the contact medium include alkyl alcohols such as ethanol, propanol, butanol, and hexanol, without wishing to be restricted in the selection of the alcohols as a result of these examples. Also especially advantageous are longer-chain alcohols, polyglycols, ketones, amines, carboxylates, sulfonates, and the like. Many of these compounds lower the surface tension or raise the conductivity.

A lowering in the surface tension may also be achieved by adding small amounts of nonionic and/or anionic and/or cationic surfactants to the contact medium. The most simple way of achieving this is by using commercial washing compositions or soap solutions, preferably in a concentration of a few g/l in water as the contact medium. Particularly suitable compounds are special surfactants which can be used even at low concentrations. Examples thereof include sulfonium surfactants (e.g., β-di (hydroxyalkyl)sulfonium salt), and also, for example, ethoxylated nonylphenylsulfonic acid ammonium salts or block copolymers, especially diblock copolymers. Here, reference may be made in particular to the state of the art under “surfactants” in Ullmann's Encyclopedia of Industrial Chemistry, Sixth Edition, 2000 Electronic Release, Wiley-VCH, Weinheim 2000.

As contact media it is possible to use the abovementioned liquids, even without the addition of water, in each case alone or in combination with one another.

In order to improve the properties of the contact medium (for example, for increasing the shearing resistance, reducing the transfer of surfactants or the like to the surface of the liner, and thus improved cleaning possibilities of the end product), salts, gels, and similar viscosity-increasing additives may also be added with advantage to the contact medium and/or to the adjuvants used.

Moreover, the roller can be macroscopically smooth or may have a surface with a low level of structuring. It has been found appropriate for the roller to possess a surface structure, especially a surface roughening. This allows wetting by the contact medium to be improved.

The process proceeds to particularly good effect if the roller is temperature-controllable, preferably with a range from −30° C. to 200° C., with very particular preference from 5° C. to 25° C.

The contact medium is preferably applied to the roller, although it is also possible to carry out contactless application, by spraying, for example.

In order to prevent corrosion, the roller is commonly coated with a protective coat. This coat is preferably selected so that it is wetted effectively by the contact medium. In general, the surface is conductive. It may also be more favorable, however, to coat it with one or more coats of insulating or semiconducting material.

Where a liquid is used as the contact medium, one outstanding procedure is to run a second roller, advantageously having a wettable or absorbent surface, through a bath containing the contact medium, said roller then becoming wetted by or impregnated with the contact medium and applying a film of said contact medium by contact with the roller.

The oriented PSA on the chill roll provided with the contact medium is crosslinked preferably immediately, then is transferred onto the carrier material.

The characterization of the orientation within the acrylic PSAs is dependent on the coating process. The orientation (the degree of anisotropy) can be controlled, for example, by the die temperature and coating temperature and also by the molecular weight of the polymer.

With further advantage, the degree of anisotropy of the pressure sensitive adhesive can be adjusted, alterantively or additionally, by controlling the draw ratio between the coating and the crosslinking and/or the relaxation time. The degree of orientation is freely adjustable through the die gap width. The thicker the PSA film expressed from the coating die, the greater the extent to which the adhesive can be drawn to a relatively thin PSA film on the carrier material. This drawing operation may be freely adjusted not only by the freely adjustable die width but also by the web speed of the decreasing carrier material.

The intensity of UV irradiation, moreover, likewise serves as an adjusting parameter for the degree of orientation. By raising the UV dose it is possible to reduce the degree of orientation. The intensity of irradiation therefore serves to vary the degree of crosslinking, to vary the technical adhesive properties, and to control the anisotropy.

UV crosslinking is effected by brief irradiation with ultraviolet radiation in a wavelength range from 200 to 400 nm, depending on the UV photoinitiator used, especially using high or medium pressure mercury lamps with an output of from 80 to 240 W/cm. The irradiation intensity is adapted to the respective quantum yield of the UV photoinitiator, the degree of crosslinking to be brought about, and for setting the extent of the orientation.

In one advantageous version of the inventive processes the degree of anisotropy of the pressure sensitive adhesive is adjusted by controlling the dose of the UV radiation.

A further option is to crosslink the polyacrylate PSA with electron beams. Typical irradiation equipment which may be used includes linear cathode systems, scanner systems, and segmented cathode systems, where electron beam accelerators are concerned. A detailed description of the state of the art, and the most important process parameters, can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The irradiation dose employed ranges between 5 to 150 kGy, in particular between 20 and 100 kGy.

The orientation of the adhesive can be measured with a polarimeter, by infrared dichroism, or using X-ray scattering. It is known that in many cases the orientation in acrylic PSAs in the uncrosslinked state is retained only for a few days. During rest or storage, the system relaxes and loses its preferential direction. As a result of crosslinking after coating, this effect can be strengthened significantly. The relaxation of the oriented polymer chains converges toward zero, and the oriented PSAs can be stored for a very long period of time without loss of their preferential direction.

In addition to measuring the orientation by determining the Δn (see test B), the measurement of the shrinkback in the free film (see test D) is likewise suitable for determining the orientation and the anisotropic properties of the PSA.

Advantageously, the orientation is controlled such that the degree of orientation, expressed through the shrinkback in accordance with test D (shrinkback measurement in the free film), is at least 3%. In one onward development of the inventive process polymers are used for which the shrinkback is at least 30%, in one preferred version at least 50%.

With further advantage the refractive index in the preferential direction, n_{MD}, measured by test B version 2 for the oriented polymers is greater than the refractive index measured in a direction perpendicular to the preferential direction, n_{CD}, the difference Δn=n_{MD}−n_{CD} being in particular at least 1·10⁻⁶.

In addition to the processes described, the orientation may also be produced following coating. In that case, then, an extensible carrier material is preferably employed, with the PSA being drawn at the same time as stretching. In this case it is also possible to use acrylic PSAs coated conventionally from solution or from water. In one preferred procedure, then, this drawn PSA is in turn crosslinked with UV radiation.

The invention provides, in addition to the above, an anisotropic pressure sensitive adhesive obtainable by at least one of the aforementioned processes, and also provides for the use of a pressure sensitive adhesive prepared by at least one of the aforementioned processes for a single-sided or double-sided adhesive tape.

The processes of the invention are described below by means of experiments. The following test methods have been employed in order to evaluate the properties of the anistropic PSAs prepared.

Test methods

180° Bond Strength Test (Test A)

A strip, 20 mm wide, of an acrylic pressure-sensitive adhesive coated onto a polyester or siliconized release paper was applied to steel plates. Depending on direction and drawing, longitudinal or transverse specimens were bonded to the steel plate. The PSA strip was pressed onto the substrate twice using a 2 kg weight. The adhesive tape was then immediately peeled from the substrate at an angle of 180° and at 30 mm/min. The steel plates were washed twice with acetone and once with isopropanol. The results are reported in N/cm and are averaged from three measurements. All measurements were conducted at room temperature under controlled-climate conditions.

Measurement of the Birefringence (Test B)

Version 1

Two crossed polaroid filters were placed in the sample beam of a Uvikon 910 spectrophotometer. Oriented acrylates were fixed between two slides. The path length of the oriented sample was determined from preliminary experiments by means of thickness gauges. The sample thus prepared was placed in the measuring beam of the spectrophotometer with its direction of orientation deviating in each case by 45° from the optical axes of the two polaroid filters. The transmission, T, was then monitored over time by means of a time-resolved measurement. The transmission data were then used to determine the birefringence in accordance with the following relationship:

T=sin²(π×R) where R=retardation.

The retardation R is made up as follows:

$$R = \frac{d}{λ} Δ n$$

where d=sample thickness.

The transmission is also given from:

$$T = \frac{{I}_{t}}{{I}_{0}}$$

This ultimately provides, for the birefringence:

$$Δ n = \frac{λ}{π d} arcsin \sqrt{T}$$

I=intensity

T=transmission

λ=wavelength

Δn=birefringence

R=retardation

Version 2

The birefringence was measured with an experimental setup such as described analogously in the Encyclopedia of Polymer Science, John Wiley & Sons, vol. 10, p. 505, 1987 as a circular polariscope. The light emitted by a diode-pumped solid-state laser of wavelength λ=532 nm is first of all linearly polarized by a polaroid filter and then circularly polarized using a λ/4 plate with λ=532 nm. The laser beam thus polarized is then passed through the oriented acrylate composition. Since acrylate compositions are highly transparent, the laser beam is able to pass through the composition virtually unhindered. Where the polymer molecules of the acrylate composition are oriented, this results in a change in the polarizability of the acrylate composition depending on observation angle (birefringence). As a result of this effect, the E vector of the circularly polarized laser beam undergoes a rotation about the axis of progression of the laser beam. After departing the sample, the laser beam thus manipulated is passed through a second λ/4 plate with λ=532 nm whose optical axis deviates by 90° from the optical axis of the first λ/4 plate. This filter is followed by a second polaroid filter which likewise deviates by 90° from the first polaroid filter. Finally, the intensity of the laser beam is measured using a photosensor, and Δn is determined as described under Version 1.

Determination of the Gel Fraction (Test C)

After careful drying, the solvent-free adhesive samples are welded into a pouch made of polyethylene nonwoven (Tyvek nonwoven). The gel index is determined from the difference in the sample weights before and after extraction with toluene.

Measurement of the Shrinkback (Test D)

The pressure sensitive adhesive is first coated onto a temporary backing (e.g., siliconized release paper) at application rates of 50 g/m². Strips with a width of at least 30 mm and a length of 20 cm were cut parallel to the coating direction of the hotmelt. Of 8 strips, the adhesive layers were laminated to one another, in order to give comparable layer thicknesses. The specimen obtained in this way was then cut to a width of exactly 20 mm. The two ends of the specimen thus obtained were overstuck with paper strips so as to leave adhesive free between the paper strips with a spacing of 15 cm. The test specimen thus prepared was then suspended vertically at room temperature and the change in length was monitored over time until no further shrinkage of the sample could be found. The initial length reduced by the final value (i.e. the “shortening”) was then reported, relative to the initial length, as the shrinkback, in percent.

For measuring the orientation after a longer time, the coated and oriented pressure sensitive adhesives were stored in the form of swatches for a prolonged period, test specimens were then prepared as above and these were then analyzed.

Gel Permeation Chromatography GPC (Test E)

The average molecular weights M_{w} and Mₙ and the polydispersity PD were determined by gel permeation chromatography. The eluent used was THF containing 0.1% by volume trifluoroacetic acid. Measurement was made at 25° C. The precolumn used was PSS-SDV, 5 μ, 10³ Å, ID 8.0 mm×50 mm. Separation was carried out using the columns PSS-SDV, 5 μ, 10³ and also 10⁵ and 10⁶ each with ID 8.0 mm×300 mm. The sample concentration was 4 g/l, the flow rate 1.0 ml per minute. Measurement was made against PMMA standards.

Preparation of the Samples

### EXAMPLE 1

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (98/2). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (98/2). After 1:45 h, 400 g of acetone/isopropanol (98/2) were added. After 2 h, 1.2 g of 2,2′-azoisobutyronitrile (AIBN) in solution in 20 g of acetone were added. After 5, 6, and 7 h, in each case 2 g of dicyclohexyl dioxypercarbonate (Perkadox 16® from Akzo Nobel) in solution in each case in 20 g of acetone were added. After a reaction time of 7 h, the mixture was diluted with 600 g of acetone/isopropanol (98/2). After a reaction time of 24 h, the reaction was terminated by cooling to room temperature. After cooling, 10 g of isopropylthioxanthone (Speedcure ITX® from Rahn) were added and completely dissolved.

### EXAMPLE 2

A 10 L reactor conventional for radical polymerizations was charged with 60 g of acrylic acid, 1800 g of 2-ethylhexyl-acrylate, 20 g of maleic anhydride, 120 g of N-isopropylacrylamide and 666 g of acetone/isopropanol (97/3). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (97/3). After 1:45 h, 400 g of acetone/isopropanol (97/3) were added. After 2 h, 1.2 g of 2,2′-azoisobutyronitrile (AIBN) in solution in 20 g of acetone were added. After 5, 6, and 7 h, in each case 2 g of dicyclohexyl dioxypercarbonate (Perkadox 16® from Akzo Nobel) in solution in each case in 20 g of acetone were added. After a reaction time of 6 h, the mixture was diluted with 600 g of acetone/isopropanol (97/3). After a reaction time of 24 h, the reaction was terminated by cooling to room temperature. After cooling, 10 g of isopropylthioxanthone (Speedcure ITX® from Rahn) were added and completely dissolved.

### EXAMPLE 3

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (95/5). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (95/5). After 2 h, 1.2 g of 2,2′-azoisobutyronitrile (AIBN) in solution in 400 g of acetone/isopropanol (95/5) were added. After a reaction time of 4 h, the mixture was diluted with 400 g of acetone/isopropanol (95/5). After 2 h, 1.2 g of 2,2′-azoisobutyronitrile (AIBN) in solution in 20 g of acetone were added. After 5, 6, and 7 h, in each case 2 g of dicyclohexyl dioxypercarbonate (Perkadox 16®from Akzo Nobel) in solution in each case in 20 g of acetone were added. After a reaction time of 5:30, 7, and 8:30 h, the mixture was diluted in each case with 400 g of acetone/isopropanol (95/5). After a reaction time of 24 h, the reaction was terminated by cooling to room temperature. After cooling, 10 g of isopropylthioxanthone (Speedcure ITX® from Rahn) were added and completely dissolved.

### EXAMPLE 4

A 10 L reactor conventional for radical polymerizations was charged with 60 g of acrylic acid, 1800 g of 2-ethylhexyl acrylate, 20 g of maleic anhydride, 120 g of N-isopropylacrylamide and 666 g of acetone/isopropanol (93/7). After nitrogen gas had been passed through for 45 minutes with stirring, the reactor was heated to 58° C. and 0.6 g of 2,2′-azoisobutyronitrile (AIBN) in solution in 20 g of acetone was added. The external heating bath was then heated to 70° C. and the reaction was carried out constantly at this external temperature. After a reaction time of 45 minutes, 0.2 g of Vazo 52® from DuPont in solution in 10 g of acetone was added. After a reaction time of 70 minutes, a further 0.2 g of Vazo 52® from DuPont in solution in 10 g of acetone was added, and after a reaction time of 85 minutes 0.4 g of Vazo 52® from DuPont in solution in 400 g of acetone/isopropanol (93/7). After 2 h, 1.2 g of 2,2′-azoisobutyronitrile (AIBN) in solution in 20 g of acetone were added. After 2:10 h, the mixture was diluted with 400 g of acetone/isopropanol (93/7). After 5, 6, and 7 h, in each case 2 g of dicyclohexyl dioxypercarbonate (Perkadox 16® from Akzo Nobel) in solution in each case in 20 g of acetone were added. In addition after a reaction time of 5, 7, and 8:30 h, the mixture was diluted in each case with a further 400 g of acetone/isopropanol (93/7). After a reaction time of 24 h, the reaction was terminated by cooling to room temperature. After cooling, 10 g of isopropylthioxanthone (Speedcure ITX® from Rahn) were added and completely dissolved.

Coating

The examples described were freed from the solvent in a vacuum drying cabinet. A vacuum of 10 torr was applied and the products slowly heated to 100° C. The hotmelt PSA was then coated using a Pröls melt die. The coating temperature was 160° C. Coating took place at 20 m/min onto a siliconized release paper from Laufenberg. The die gap width was 200 μm. After the coating operation, the amount of pressure-sensitive adhesive on the release paper was 50 g/m². Coating was carried out with application at a pressure of 6 bar to the melt die in order that the hotmelt PSA could be pressed through the die.

Crosslinking

UV crosslinking was carried out, unless described otherwise, at room temperature 15 minutes after coating. UV crosslinking was carried out using a UV crosslinking unit from Eltosch. The UV lamp used was a medium pressure mercury lamp with an intensity of 120 W/cm². The web speed was 20 m/min, and crosslinking was carried out with full radiation. In order to vary the UV irradiation dose, the PSA tape was irradiated with different numbers of passes. The UV dose rises linearly with the number of passes. The UV doses were determined using the Power-Puck® from Eltosch. For example, for 2 passes a UV dose of 0.8 J/cm² was measured, for 4 passes 1.6 J/cm², for 8 passes 3.1 J/cm², and for 10 passes 3.8 J/cm².

Results

In order to investigate the orientation of acrylic PSAs and their crosslinkability, first of all a variety of acrylic PSAs were prepared by free radical polymerization. In terms of temperature stability and flow viscosity, all of the adhesives can be processed by the hotmelt process. The acrylic PSAs prepared were polymerized in different solvent mixtures. To analyze the polymerizations, Test E was carried out. The results are summarized in Table 1.

TABLE 1
Molecular weights of the polymers in g/mol by Test E

| | Mₙ | M_{w} |
|---|---|---|
| Example 1 | 112 580 | 978 010 |
| Example 2 | 98 283 | 825 310 |
| Example 3 | 75 058 | 626 060 |
| Example 4 | 64 245 | 559 412 |

After the polymerization, examples 1-4 were freed from the solvent and processed from the melt. Coating was carried out through a melt die at 160° C., onto a release paper which was left at room temperature. After 15 minutes, UV crosslinking was carried out with different doses. In order to determine the anisotropic properties, first of all the shrinkback in the free film was measured in accordance with Test D. To determine the degree of crosslinking, Test C was conducted, and hence the gel fraction was determined. The gel fraction indicates the percentage amount of the crosslinked polymer. The results are summarized in Table 2.

TABLE 2

| | Number | Shrinkback | Gel index |
|---|---|---|---|
| | of UV | in % by | in % by |
| | passes | Test D | Test C |
| Example 1 | 2 | 57 | 32 |
| | 3 | 50 | 50 |
| | 4 | 44 | 60 |
| | 5 | 37 | 64 |
| | 6 | 33 | 68 |
| | 8 | 27 | 73 |
| Example 2 | 2 | 52 | 29 |
| | 3 | 44 | 48 |
| | 4 | 38 | 52 |
| | 5 | 33 | 64 |
| | 6 | 30 | 70 |
| | 8 | 26 | 75 |
| Example 3 | 2 | 41 | 15 |
| | 3 | 34 | 25 |
| | 4 | 30 | 38 |
| | 5 | 21 | 47 |
| | 6 | 19 | 56 |
| | 8 | 15 | 60 |
| Example 4 | 2 | 26 | 10 |
| | 3 | 25 | 23 |
| | 4 | 10 | 37 |
| | 5 | 5 | 49 |

Table 2 indicates that a large number of oriented PSAs can be prepared by the inventive process. The degree of orientation may be very different. Thus is is possible to prepare polyacrylates having a shrinkback of 5% or having a shrinkback of 57%. Moreover, examples 1 to 4 demonstrate that by means of the UV dose appleid it is possible to control the shrinkback and hence also the orientation. From the figures it can be inferred that the shrinkback decreases when the UV does is raised. At the same time there is of course an increase in the gel index. This in turn influences the technical adhesive properties, so that by means o the UV does applied it is possible to control not only the technical adhesive properties but also the extent of orientation.

In order to confirm the influence of degree of crosslinking on the technical adhesive properties, the bond strengths were again measured in accordance with Test A. The results are listed in Table 3.

TABLE 3

| | Number | BS in | Gel index |
|---|---|---|---|
| | of UV | N/cm by | in % by |
| | passes | Test A | Test C |
| Example 1 | 2 | 4.2 | 32 |
| | 3 | 3.9 | 50 |
| | 4 | 3.7 | 60 |
| | 5 | 3.5 | 64 |
| | 8 | 3.2 | 73 |
| Example 2 | 2 | 4.3 | 29 |
| | 3 | 3.8 | 48 |
| | 5 | 3.5 | 64 |
| | 8 | 3.3 | 75 |
| Example 3 | 2 | 4.2 | 15 |
| | 3 | 3.9 | 25 |
| | 4 | 3.6 | 38 |
| | 6 | 3.3 | 56 |
| | 8 | 3.2 | 60 |
| Example 4 | 2 | 4.1 | 10 |
| | 3 | 3.5 | 23 |
| | 4 | 3.4 | 37 |
| | 5 | 3.2 | 49 |

BS = instantaneous bond strength on steel

For use as an oriented PSA, the retention of the orientation is essential. For a number of examples, therefore, the shrinkback was measured in accordance with Test D following storage for one month at room temperature. The figures are set out in Table 4.

TABLE 4

| | Number of UV | Shrinkback in % by | Shrinkback in % by |
|---|---|---|---|
| | passes | Test D | Test D after 30 days |
| Example 1 | 2 | 57 | 55 |
| | 3 | 50 | 48 |
| | 4 | 44 | 41 |
| | 5 | 37 | 37 |
| | 6 | 33 | 30 |
| | 8 | 27 | 25 |
| Example 2 | 2 | 52 | 50 |
| | 3 | 44 | 40 |
| | 4 | 38 | 36 |
| | 5 | 33 | 32 |
| | 6 | 30 | 28 |
| | 8 | 26 | 24 |
| Example 3 | 2 | 41 | 40 |
| | 3 | 34 | 32 |
| | 4 | 30 | 27 |
| | 5 | 21 | 19 |
| | 6 | 19 | 15 |
| | 8 | 15 | 12 |
| Example 4 | 2 | 26 | 24 |
| | 3 | 25 | 20 |
| | 4 | 10 | 8 |
| | 5 | 5 | 4 |

From Table 4 it can be inferred that in some cases the shrinkback does go down, but that the percentage changes are very small. All of the examples depicted still have a shrinkback even after storage for 30 days, exhibit very little relaxation if any, and continue to possess anisotropic properties.

The orientation within the acrylic PSAs was determined, moreover, by quantifying the birefringence. The refractive index n of a medium is given by the ratio of the speed of light in a vacuum, c₀, to the speed of light in the medium in question, c (n=c₀/c), n being a function of the wavelength of the respective light. As a measure of the orientation of the pressure-sensitive adhesive, use is made of the difference Δn between the refractive index measured in a preferential direction (stretching direction, machine direction MD), n_{MD}, and the refractive index measured in a direction perpendicular to the preferential direction (cross-direction, CD), n_{CD}. In other words, Δn=n_{MD}−n_{CD}; this figure is obtainable through the measurements described in Test B.

All examples showed orientation of the polymer chains. The Δn values found are listed in Table 5.

TABLE 5

| | Number of UV | Shrinkback in % | Δn values |
|---|---|---|---|
| | passes | by Test D | Test 2 |
| Example 1 | 2 | 57 | 1.8 · 10⁻⁴ |
| | 3 | 50 | 8.6 · 10⁻⁵ |
| Example 2 | 4 | 38 | 6.6 · 10⁻⁵ |
| | 5 | 33 | 2.6 · 10⁻⁵ |
| Example 3 | 5 | 21 | 9.5 · 10⁻⁶ |
| | 6 | 19 | 8.7 · 10⁻⁶ |
| Example 4 | 4 | 10 | 5.1 · 10⁻⁶ |
| | 5 | 5 | 2.6 · 10⁻⁶ |

Δn values: Difference between the refractive indices n_{MD} in the direction of stretching and n_{CD} perpendicular thereto.

Orientation within the acrylic PSAs was therefore found for the samples measured, by the measurement of birefringence.

Taking into account the results, it is possible to realize new pressure-sensitive adhesive tape products which make use of this described effect. When adhesive bonds are made on cable harnesses in the engine compartment, the temperature differences which occur are in some cases very high. It is therefore preferred to use acrylic PSA tapes for such applications. In contrast to a customary commercial acrylic adhesive, an oriented adhesive will contract on heating, by the shrinkback measured and described, and so will form a firm bond from the cables and the insulating nonwoven. The advantages are retained in relation to the oriented natural rubber adhesives, these advantages being, for example, higher temperature stability in a large temperature window, and improved aging stability.

The shrinkback effect may also be utilized in the case of adhesive bonds on convex surfaces. By applying a pressure-sensitive adhesive tape to a convex surface, with subsequent heating, the PSA tape contracts and so conforms to the convexity of the substrate. In this way, adhesive bonding is greatly facilitated and the number of air inclusions between substrate and tape is greatly reduced. The PSA is able to exert its optimum effect. This characteristic can be assisted further by an oriented carrier material. Following application, under heating, both the carrier material and the oriented PSA shrink, so that the bonds on the convexity are completely stress-free.

The pressure-sensitive adhesives of the invention likewise offer a wide range for applications which utilize advantages of the low extension in the longitudinal direction and the possibility of shrinkback in an advantageous way.

The property of the pre-extension of the pressure-sensitive adhesives can also be utilized to outstanding effect. A further exemplary field of use for such highly oriented acrylic PSAs is that of strippable double-sided adhesive bonds. Unlike conventional strippable products, the oriented PSA is already pre-extended to several 100%, so that in order to remove the double-sided bond the acrylic PSA need only be stretched by a few percent more in the stretching direction (MD). With particular preference, these products are produced as acrylic hotmelts with a film thickness of several 100 μm. Straight acrylics are used with particular preference. As compared with conventional systems (multilayer systems, SIS adhesives), the oriented acrylic strips are transparent, stable toward aging, and inexpensive to manufacture.

1. A process for preparing anisotropic pressure sensitive adhesives, wherein pre-oriented polymer based on acrylate and/or methacrylate is crosslinked by irradiation with UV light.

2. The process of claim 1, wherein the irradiation with UV light is carried out with the pre-oriented polymer in the form of a layer.

3. The process of claim 2, wherein the polymer layer is produced from the melt, by coating a permanent or temporary substrate through a melt die, through an extrusion die or by a roller coating method.

4. A process for preparing anisotropic pressure sensitive adhesives, wherein a monomer mixture comprised of at least 50% by weight of acrylic monomers selected from the group consisting of compounds of the following formula 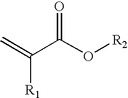
with R₁ independently at each occurrence chosen from H and/or CH₃ and R₂ independently at each occurrence chosen from the group of the branched or unbranched, saturated, substituted or unsubstituted hydrocarbon chains having 2 to 30 carbon atoms is polymerized to form a polymer, from which a polymer layer is produced, the polymer being oriented during layer production,
and the oriented polymer is crosslinked by irradiation with UV light.

5. The process of of claim 1, wherein the average molecular weight M_{w} of the polymer is at least 200 000 g/mol.

6. The process of claim 1, wherein one or more UV initiators and/or one or more crosslinkers are added to the polymer to be crosslinked.

7. The process of claim 1, wherein the degree of anisotropy of the pressure sensitive adhesive is adjusted by controlling the dose of the UV radiation.

8. The process of claim 1, wherein the degree of anisotropy of the pressure sensitive adhesive is adjusted by controlling one or more of the following process parameters: coating temperature, molecular weight of the polymer, draw ratio, and relaxation time between coating and crosslinking.

9. An anisotropic pressure sensitive adhesive obtainable by the process of claim 1.

10. A single-sided or double-sided adhesive tape comprising a pressure-sensitive adhesive prepared by the process of claim 1.

11. The process of claim 6, wherein said crosslinkers are selected from the group consisting of difunctional and polyfunctional acrylates, methacrylates, isocyanates, epoxides and mixtures thereof.
